(19) United States
(12) Patent Application Publication
(10) Pub. No.: US 2025/0191214 A1
(43) Pub. Date: Jun. 12, 2025

(54) SEMI-SUPERVISED TRAINING-BASED THREE-DIMENSIONAL POSE ESTIMATION MODEL TRAINING METHOD FOR SIGN LANGUAGE GESTURE RECOGNITION

(71) Applicant: Korea Electronics Technology Institute, Seongnam-si (KR)

(72) Inventors: Han Mu PARK, Seongnam-si (KR); Sang Won LEE, Seoul (KR)

(73) Assignee: Korea Electronics Technology Institute, Seongnam-si (KR)

(21) Appl. No.: 18/929,731

(22) Filed: Oct. 29, 2024

(30) Foreign Application Priority Data
Dec. 12, 2023 (KR) 10-2023-0179307

(51) Int. Cl. G06T 7/70

(52) U.S. Cl. CPC G06T 7/70; G06T 2207/20081

(57) ABSTRACT

There is provided a method for training a 3D pose estimation model based on semi-supervised training for sign language gesture recognition. A method for training a 3D pose estimation model according to an embodiment includes: performing supervised training with respect to the 3D pose estimation model which receives 2D pose information and estimates 3D pose information; estimating 3D pose information by inputting 2D pose information to the 3D pose estimation model for which the supervised training is performed; generating another 3D pose information regarding the 2D pose information; and performing self-supervised training with respect to the 3D pose estimation. Accordingly, performance of the 3D pose estimation model can be enhanced even with a small amount of training dataset with labels.

### CROSS-REFERENCE TO RELATED APPLICATION(S) AND CLAIM OF PRIORITY

This application is based on and claims priority under 35 U.S.C. § 119 to Korean Patent Application No. 10-2023-0179307, filed on Dec. 12, 2023, in the Korean Intellectual Property Office, the disclosure of which is herein incorporated by reference in its entirety.

### BACKGROUND

### Field

The disclosure relates to training a machine learning model, and more particularly, to a method for training a three-dimensional (3D) pose estimation model which is a machine learning model for estimating a 3D pose from a 2D pose for sign language gesture recognition.

### Description of Related Art

Sign language consists of cheremes and non-manual signals, and the meaning of sign language varies depending on not only hand but also handshape, hand orientation, hand location, hand movement, and facial expression. Therefore, accurate information on sign language gestures is required for sign language gesture recognition and translation.

Sign language video datasets may be transformed into 2D information as sign language gestures in a 3D space are recorded on the video. In this case, there may be a negative impact on sign language gesture recognition performance, such as ambiguity in depth or occlusion of other parts of the body depending on gestures.

To solve this ambiguity, techniques to estimate 3D pose information from a 2D sign language video are needed, and recent AI techniques for estimating 3D pose information require a large amount of 3D pose information labels.

However, it is difficult to collect data enough to train a signal language gesture recognition model since sign language video data should be acquired through video recording using real deaf people. In addition, even if data is collected, labeling 3D pose information may cost high.

### SUMMARY

The disclosure has been developed in order to solve the above-described problems, and an object of the disclosure is to provide a machine learning model training method which performs supervised training with respect to a 3D pose estimation model with a small amount of 3D pose information labels, and then, trains the 3D pose information estimation model with a large amount of sign language video data without labels based on self-supervised learning.

According to an embodiment of the disclosure to achieve the above-described object, there is provided a method for training a 3D pose estimation model, the method including: performing supervised training with respect to the 3D pose estimation model which receives 2D pose information and estimates 3D pose information; estimating 3D pose information by inputting 2D pose information to the 3D pose estimation model for which the supervised training is performed; generating another 3D pose information regarding the 2D pose information; and performing self-supervised training with respect to the 3D pose estimation model by computing an error between the estimated 3D pose information and the generated another 3D pose information.

Performing the supervised training may include performing supervised training with respect to the 3D pose estimation model by using a training dataset which has an input of 2D pose information and has a label of 3D pose information.

According to an embodiment, the method may further include generating 2D pose information from a 2D video, and estimating may include inputting the generated 2D pose information to the 3D pose estimation model for which the supervised training is performed.

Generating another 3D pose information may include generating another 3D pose information from the estimated 3D pose information.

Generating another 3D pose information may include: transforming the estimated 3D pose information into 2D pose information; and estimating another 3D pose information from the transformed 2D pose information.

Estimating another 3D pose information may include estimating 3D pose information which is outputted when the transformed 2D pose information is inputted to the 3D pose estimation model as another 3D pose information.

Transforming may include transforming the estimated 3D pose information into 2D pose information by projecting the estimated 3D pose information onto a 2D plane.

According to an embodiment, the method may further include estimating 3D pose information by inputting 2D pose information into the trained 3D pose estimation model.

The 2D video may be a sign language video.

According to another aspect of the disclosure, there is provided a system for training a 3D pose estimation model, the system including: a supervised training unit configured to perform supervised training with respect to the 3D pose estimation model which receives 2D pose information and estimates 3D pose information; and a self-supervised training unit configured to estimate 3D pose information by inputting 2D pose information to the 3D pose estimation model for which the supervised training is performed, to generate another 3D pose information regarding the 2D pose information, and to perform self-supervised training with respect to the 3D pose estimation model by computing an error between the estimated 3D pose information and the generated another 3D pose information.

According to still another aspect of the disclosure, there is provided a method for training a 3D pose estimation model, the method including: estimating 3D pose information by inputting 2D pose information to the 3D pose estimation model; generating another 3D pose information regarding the 2D pose information; and performing self-supervised training with respect to the 3D pose estimation model by computing an error between the estimated 3D pose information and the generated another 3D pose information.

According to embodiments of the disclosure as described above, a 3D pose estimation model may be trained in a supervised training method by using a small amount of 3D pose information labels, and then, may be additionally trained by using a large amount of sign language video data without labels, based on self-supervised training. Accordingly, performance of the 3D pose estimation model can be enhanced even with a small amount of training datasets with labels.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a 3D pose estimation model training system according to an embodiment of the disclosure;

FIG. 2 is a view illustrating a sign language dataset including 2D/3D pose information;

FIG. 3 is a view illustrating a detailed configuration of a 3D pose estimation supervised training unit and a training process; and

FIG. 4 is a view illustrating a detailed configuration of a 3D pose estimation self-supervised training unit and a training process.

### DETAILED DESCRIPTION

Hereinafter, the disclosure will be described in more detail with reference to the accompanying drawings.

Embodiments of the disclosure provide a method and a system for training a 3D pose estimation model based on semi-supervised learning for sign language gesture recognition.

The disclosure relates to a technique for processing pose information for training according to whether 3D pose information labels of a sign language video dataset for sign language gesture recognition are provided, and transforming 2D pose information extracted from the sign language video data into 3D pose information through an artificial neural network layer model, which finely adjusts a pre-trained model based on self-supervised learning by using sign language video data without 3D pose information.

Through this, a 3D pose estimation model may be trained by using a small amount of 3D pose information label data, and performance may be enhanced by using a large amount of sign language video data without label information for training based on a self-supervised training technology.

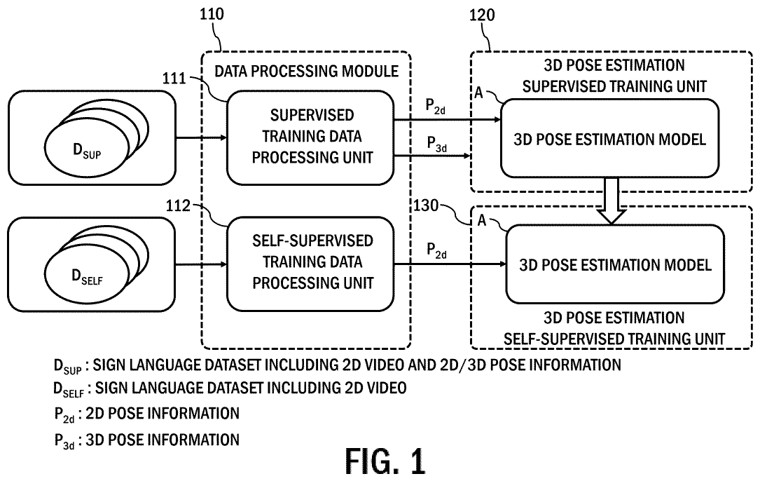

FIG. 1 is a view illustrating a configuration of a 3D pose estimation model training system according to an embodiment of the disclosure.

The 3D pose estimation model training system according to an embodiment of the disclosure may include a data processing module 110, a 3D pose estimation supervised training unit 120, and a 3D pose estimation self-supervised training unit 130 as shown in the drawing.

The data processing module 110 is a module for generating training data to be used for training a 3D pose estimation model A, and may include a supervised training data processing unit 110 and a self-supervised training data processing unit 112.

The supervised training data processing unit 111 generates a training dataset to be used for supervised training of the 3D pose estimation model A from a sign language dataset D_{SUP} which includes a 2D video (sign language video) and 2D/3D pose information thereon.

Specifically, the supervised training data processing unit 111 may configure a supervised training dataset that has an input of 2D pose information P_{2d} and has a label of 3D pose information P_{3d}, and may transmit the supervised training dataset to the 3D pose estimation supervised training unit 120.

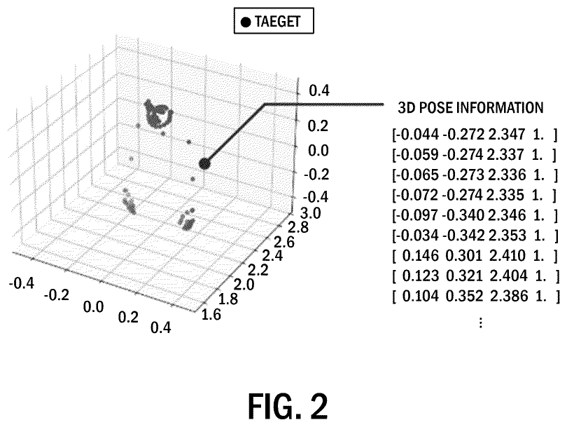

The sign language dataset D_{SUP} including the 2D/3D pose information may be expressed as shown in FIG. 2. The corresponding dataset may include a sign language video comprised of 2D sign language images of a plurality of frames, and a pairs of 2D and 3D pose information for each frame.

The self-supervised training data processing unit 112 generates a training dataset to be used for self-supervised training of the 3D pose estimation model A from a sign language dataset D_{SELF} including only the 2D video (sign language video).

Specifically, the self-supervised training data processing unit 112 may generate 2D pose information from the 2D video, and may transmit the generated 2D pose information to the 3D pose estimation self-supervised training unit 120 as a self-supervised training dataset.

The 3D pose estimation supervised training unit 120 may perform supervised training with respect to the 3D pose estimation model A with the supervised training dataset transmitted from the supervised training data processing unit 111.

The 3D pose estimation self-supervised training unit 130 may perform supervised training with respect to the 3D pose estimation model A, which has been trained by the 3D pose estimation supervised training unit 120, with the self-supervised training dataset transmitted from the self-supervised training data processing unit 112.

The 3D pose estimation model A may be a machine learning model for receiving 2D pose information and estimating 3D pose information, and may be implemented by a deep learning network such as a convolution neural network (CNN), a transformer, etc. The 3D pose estimation model A may refer to a processor having the 3D pose estimation model A mounted therein.

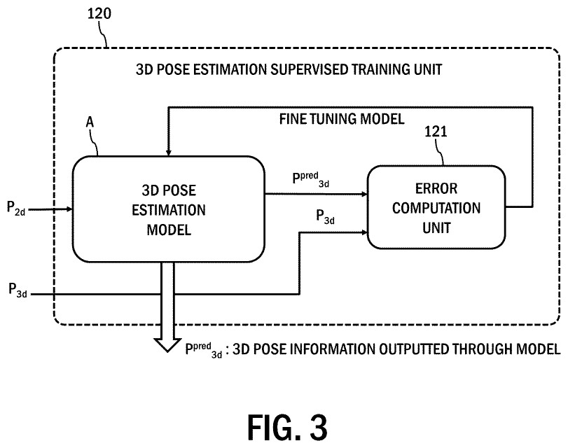

FIG. 3 is a view illustrating a detailed configuration of the 3D pose estimation supervised training unit 120 and a training process thereof.

As shown in FIG. 3, the 3D pose estimation supervised training unit 120 computes, through an error computation unit 121, an error between ‘3D pose information P^{pred}_{3d} which is estimated by inputting 2D pose information P_{2d} given as a supervised training dataset to the 3D pose estimation model A’, and ‘3D pose information P_{3d} given as a supervised training dataset’, and performs supervised training with respect to the 3D pose estimation model A by updating parameters of the 3D pose estimation model A in the direction of reducing the error.

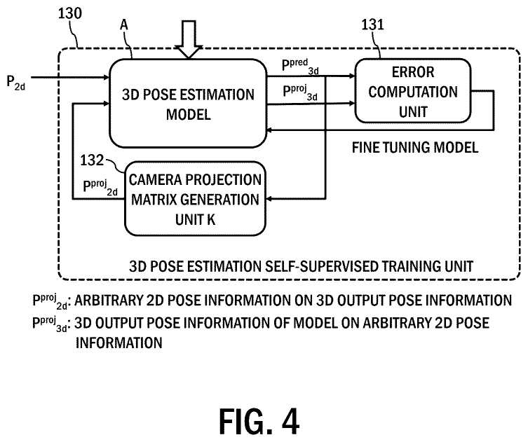

FIG. 4 is a view illustrating a detailed configuration of the 3D pose estimation self-supervised training unit 130 and a training process thereof.

As shown in FIG. 4, the 3D pose estimation self-supervised training unit 130 estimates 3D pose information P^{pred}_{3d} by inputting 2D pose information P_{2d} given as a self-supervised training dataset to the 3D pose estimation model A for which supervised training is performed by the 3D pose estimation supervised training unit 120.

The 3D pose estimation self-supervised training unit 130 generates another 3D pose information from the 3D pose information P^{pred}_{3d} estimated by the 3D pose estimation model A.

To achieve this, a camera projection matrix generation unit 132 of the 3D pose estimation self-supervised training unit 130 may project the 3D pose information P^{pred}_{3d} estimated by the 3D pose estimation model A onto a 2D plane with a camera projection matrix K to transform the 3D pose information into 2D pose information P^{proj}_{2d}.

The 3D pose estimation self-supervised training unit 130 may use, as another 3D pose information, 3D pose information P^{proj}_{3d} which is outputted when the 2D pose information P^{proj}_{2d} transformed by the camera projection matrix generation unit 132 is inputted to the 3D pose estimation model A.

An error computation unit 131 of the 3D pose estimation self-supervised training unit 130 computes an error between the 3D pose information P^{pred}_{3d} and another 3D pose information P^{proj}_{3d}, and performs self-supervised training with respect to the 3D pose estimation model A by finely adjusting the parameters of the 3D pose estimation model A in the direction of decreasing the error.

The 3D pose estimation model A which completes the training may be used to estimate 3D pose information from 2D pose information, and the estimated 3D pose information may be used for sign language recognition.

Up to now, a semi-supervised training-based 3D pose estimation model training method for sign language gesture recognition has been described in detail with reference to preferred embodiments.

In the above-described embodiments, 3D pose information estimation performance may be enhanced by training a 3D pose estimation model by using a small amount of 3D pose information label data, and using a large amount of sign language video data without label information for training based on a self-supervised training technique.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A method for training a 3D pose estimation model, the method comprising:
performing supervised training with respect to the 3D pose estimation model which receives 2D pose information and estimates 3D pose information;
estimating 3D pose information by inputting 2D pose information to the 3D pose estimation model for which the supervised training is performed;
generating another 3D pose information regarding the 2D pose information; and
performing self-supervised training with respect to the 3D pose estimation model by computing an error between the estimated 3D pose information and the generated another 3D pose information.

2. The method of claim 1, wherein performing the supervised training comprises performing supervised training with respect to the 3D pose estimation model by using a training dataset which has an input of 2D pose information and has a label of 3D pose information.

3. The method of claim 1, further comprising generating 2D pose information from a 2D video,
wherein estimating comprises inputting the generated 2D pose information to the 3D pose estimation model for which the supervised training is performed.

4. The method of claim 3, wherein generating another 3D pose information comprises generating another 3D pose information from the estimated 3D pose information.

5. The method of claim 4, wherein generating another 3D pose information comprises:
transforming the estimated 3D pose information into 2D pose information; and
estimating another 3D pose information from the transformed 2D pose information.

6. The method of claim 5, wherein estimating another 3D pose information comprises estimating 3D pose information which is outputted when the transformed 2D pose information is inputted to the 3D pose estimation model as another 3D pose information.

7. The method of claim 5, wherein transforming comprises transforming the estimated 3D pose information into 2D pose information by projecting the estimated 3D pose information onto a 2D plane.

8. The method of claim 1, further comprising estimating 3D pose information by inputting 2D pose information into the trained 3D pose estimation model.

9. The method of claim 3, wherein the 2D video is a sign language video.

10. A system for training a 3D pose estimation model, the system comprising:
a supervised training unit configured to perform supervised training with respect to the 3D pose estimation model which receives 2D pose information and estimates 3D pose information; and
a self-supervised training unit configured to estimate 3D pose information by inputting 2D pose information to the 3D pose estimation model for which the supervised training is performed, to generate another 3D pose information regarding the 2D pose information, and to perform self-supervised training with respect to the 3D pose estimation model by computing an error between the estimated 3D pose information and the generated another 3D pose information.

11. A method for training a 3D pose estimation model, the method comprising:
estimating 3D pose information by inputting 2D pose information to the 3D pose estimation model;
generating another 3D pose information regarding the 2D pose information; and
performing self-supervised training with respect to the 3D pose estimation model by computing an error between the estimated 3D pose information and the generated another 3D pose information.
